(19) United States
(12) Patent Application Publication
(10) Pub. No.: US 2019/0323289 A1
(43) Pub. Date: Oct. 24, 2019

(54) THREE-WHEELED CORD ROLLING DEVICE FOR NON-PULL CORD WINDOW BLIND

(71) Applicant: SHEEN WORLD TECHNOLOGY CORPORATION, TAICHUNG CITY (TW)

(72) Inventors: Hung-Hao CHEN, TAICHUNG CITY (TW); Ming-Che TSAI, TAICHUNG CITY (TW)

(21) Appl. No.: 16/385,195

(22) Filed: Apr. 16, 2019

(30) Foreign Application Priority Data
Apr. 19, 2018 (TW) 107113332

(51) Int. Cl. E06B 9/322; B65H 75/48

(52) U.S. Cl. CPC E06B 9/322; E06B 2009/3222; B65H 75/486

(57) ABSTRACT

A three-wheeled cord rolling device includes a driving unit having two torsion spring wheels engaged with each other and a torsion spring connecting the torsion spring wheels, and a cord rolling unit having a cord rolling wheel and two lift transmission cords. The cord rolling wheel is engaged with one of the torsion spring wheels, thereby rotatable with them synchronously. The cord rolling wheel has an axle having upper and lower axial portions and a separating portion connecting the upper and lower axial portions. The lift transmission cords are disposed on the upper and lower axial portions of the axle respectively, thereby capable of being rolled up or released from the upper and lower axial portions of the axle by the rotation of the cord rolling wheel.

### BACKGROUND OF THE INVENTION

### 1. Field of the Invention

The present invention relates to non-pull cord window blinds and more particularly, to a three-wheeled cord rolling device for a non-pull cord window blind.

### 2. Description of the Related Art

In general, as to the non-pull cord window blind, its lift transmission cords are rolled up by the cord rolling device disposed in its top beam. Owing that the lift transmission cord is tied to the bottom beam, the bottom beam is gradually moved up during the process that the lift transmission cord is rolled up, so that the slats of the window blind are folded up by upwardly moving bottom beam.

The aforesaid cord rolling device is workable for normal-sized window blind. However, for the special-sized (ex. narrow elongated type) window blind, the aforesaid cord rolling device, due to its length, is apt to interfere with other elements of the window blind. Therefore, how to simplify the structure of the aforesaid cord rolling device appropriately without affecting the transmission effect of the device is a problem that the industry eagers to solve.

### SUMMARY OF THE INVENTION

It is a primary objective of the present ion to provide a three-wheeled cord rolling device for the non-pull cord window blind, which can attain the effect of structural simplification without being affected in transmission effect.

To attain the aforesaid primary objective, the three-wheeled cord rolling device of the present invention includes a base, a driving unit, and a cord rolling unit. The driving unit has two torsion spring wheels and a torsion spring. Each of the torsion spring wheels is rotatably disposed on the base and has a first upper toothed disc, a first lower toothed disc and a first axle connecting the first upper toothed disc and the first lower toothed disc. The torsion spring connects the first axles of the two torsion spring wheels. The cord rolling unit has a cord rolling wheel, a first lift transmission cord, and a second lift transmission cord. The cord rolling wheel is rotatably disposed on the base and has a second upper toothed disc, a second lower toothed disc and a second axle. The second upper toothed disc and the second lower toothed disc are engaged with the first upper toothed disc and the first lower toothed disc of one of the torsion spring wheels of the driving unit respectively, so that the cord rolling wheel can rotate with the two torsion spring wheels synchronously. The second axle has an upper axial portion, a lower axial portion, and a separating portion. An end of the upper axial portion and an end of the lower axial portion are connected with the second upper toothed disc and the second lower toothed disc respectively. The separating portion is connected between the upper axial portion and the lower axial portion. The first lift transmission cord and the second lift transmission cord are disposed on the upper axial portion and the lower axial portion of the second axle respectively and separated from each other by the separating portion of the second axle, so that the first and second lift transmission cords can be synchronously wound around the upper and lower axial portions of the second axle or released from the upper and lower axial portions of the second axle by the rotation of the cord rolling wheel.

It can be understood from the above description that in the three-wheeled cord rolling device of the present invention, the two lift transmission cords are disposed on the same cord rolling wheel in a vertically separated manner, and the cord rolling wheel can rotate with the two torsion spring wheels synchronously by the engagement and transmission therebetween. As a result, the three-wheeled cord rolling device is shortened in length of the whole without being affected in transmission effect, thereby attaining the effect of structural simplification.

Preferably, the base is provided at two opposite ends thereof with a first opening and a second opening respectively, and the base is further provided on one side thereof with a guiding rod and a limiting ring. and the guiding rod and located correspondingly to the upper axial portion of the cord rolling wheel. Besides, the first lift transmission cord is inserted through the limiting ring and abutted against the guiding rod. An end of the first lift transmission cord is connected with the upper axial portion of the second axle. An opposing end of the first lift transmission cord extends out of the base through the first opening of the base to connect an end of a bottom beam. An end of the second lift transmission cord is connected with the lower axial portion of the second axle. An opposing end of the second lift transmission cord extends out of the base through the second opening of the base to connect an opposing end of the bottom beam. As a result, the first and second lift transmission cords can balance the force applied to the bottom beam, thereby preventing the bottom beam from inclining.

Preferably, the base further has a plurality of first vertical rods disposed adjacent to the first opening and a plurality of second vertical rods disposed adjacent to the second opening. The first lift transmission cord is abutted against at least one of the first vertical rods. The second lift transmission cord is abutted against at least one of the second vertical rods. The cord arrangement of the first and second lift transmission cords can be adjusted by the variation of the amounts and the positions of the first and second vertical rods, thereby adjusting the resistance provided on the first and second lift transmission cords.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a perspective view of the appearance of a three-wheeled cord rolling device of the present invention.

FIG. 2 is a partially exploded perspective view of the three-wheeled cord rolling device of the present invention.

FIG. 3 is a front view of the three-wheeled cord rolling device of the present invention.

FIG. 4 is a top view of the three-wheeled cord rolling device of the present invention in the condition that a top plate is removed.

### DETAILED DESCRIPTION OF THE MENTION

First of all, it is to be mentioned that same reference numerals used in the following preferred embodiment and the appendix drawings designate same or similar elements or structural features thereof throughout the specification for the purpose of concise illustration of the present invention.

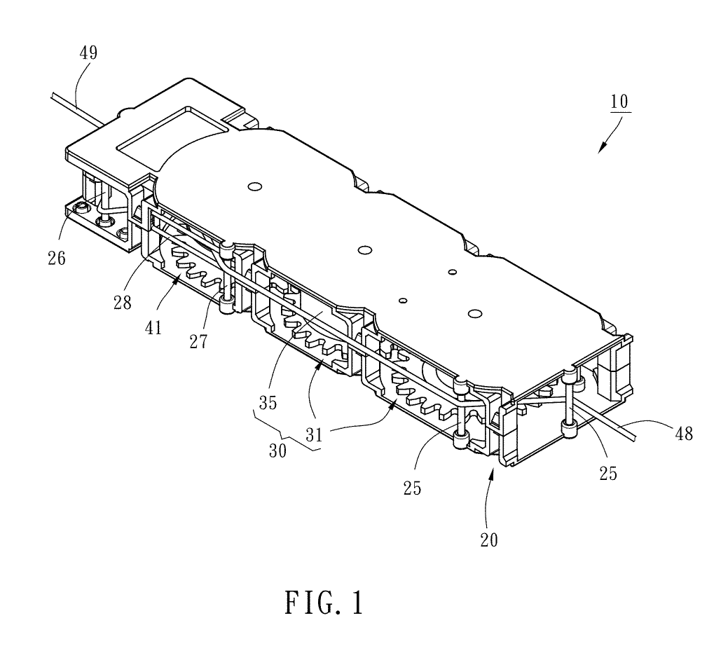

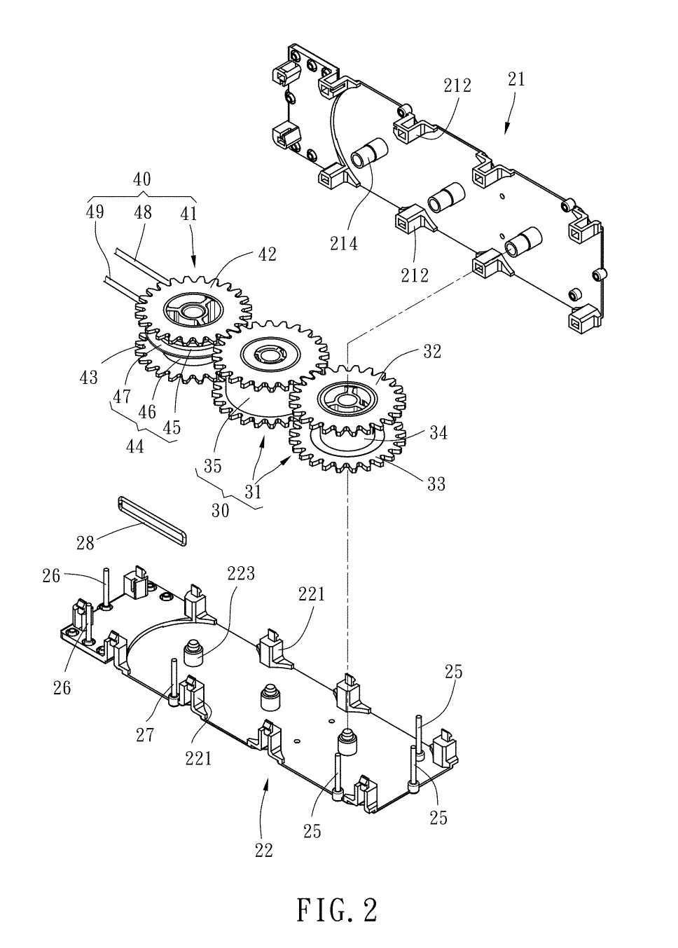

Referring to FIGS. 1-2, a three-wheeled cord rolling device 10 of the present invention includes a base 20, a driving unit 30, and a cord rolling unit 40.

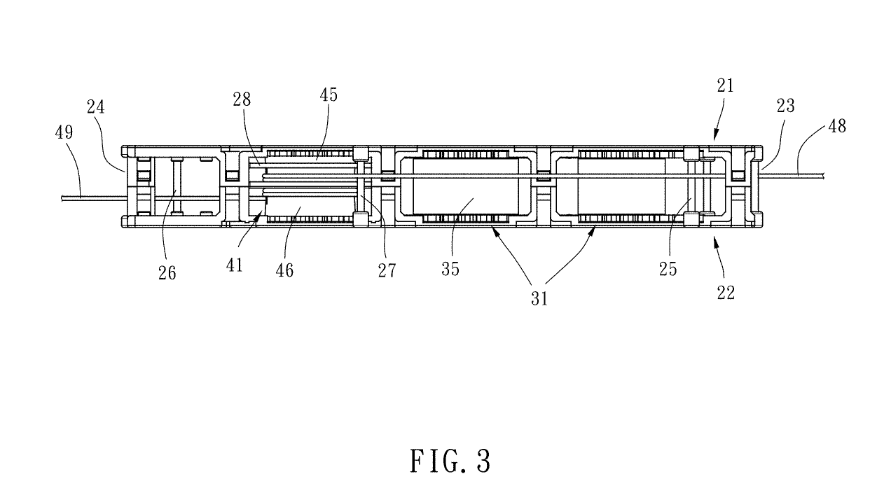

The base 20 is rectangular-shaped and has a top plate 21 and a bottom plate 22. The top plate 21 is provided on the periphery thereof with five pairs of upper supporting posts 212. The bottom plate 22 is provided on the periphery thereof with five pairs of lower supporting posts 221. The top and bottom plates 21 and 22 are combined by the engagement between the upper and lower supporting posts 212 and 221 facing each other one on one. When the combination of the top and bottom plates 21 and 22 is accomplished as shown in FIG. 3, the base 20 is provided at the right end thereof with a first opening 23, and the base 20 is provided at the left end thereof with a second opening 24. Besides, the top plate 21 is provided on the bottom surface thereof with three upper axles 214, and the bottom plate 22 is provided on the top surface thereof with three lower axles 223. When the combination of the top and bottom plates 21 and 22 is accomplished, the upper and lower axles 214 and 223 are connected with each other one on one.

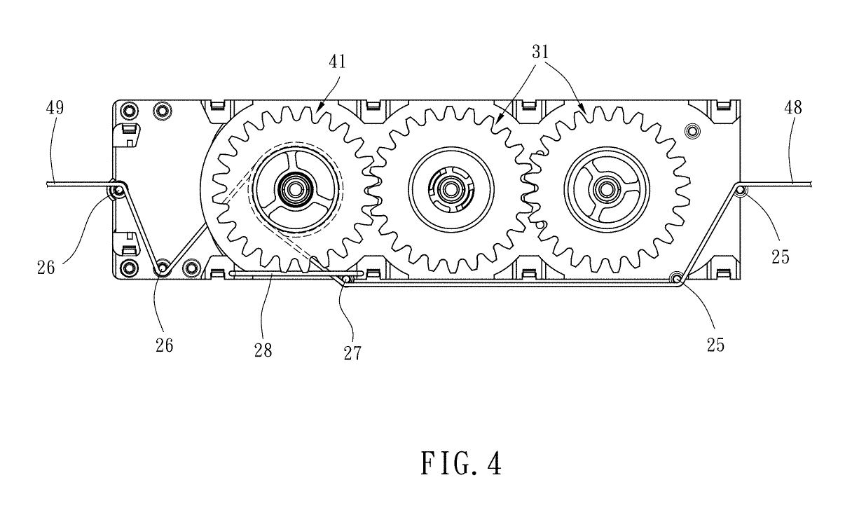

Referring to FIGS. 2 and 4, the base 20 is provided at the right end thereof with three first vertical rods 25. One of the first vertical rods 25 is located at the first opening 23. Another of the first vertical rods 25 is located on the front side of the base 20. The other of the first vertical rods 25 is located adjacent to the rear side of the base 20. The base 20 is provided at the left end thereof with two second vertical rods 26 connected between the top and bottom plates 21 and 22. One of the second vertical rods 26 is located at the second opening 24. The other of the second vertical rods 26 is located on the front side of the base 20. Besides, as shown in FIGS. 1-2, the base 20 further has a guiding rod 27 and a limiting ring 28. The guiding rod 27 is disposed on the front side of the bottom plate 22 and located adjacent to the lower supporting post 221 disposed at the middle position of the front side. The limiting ring 28 encircles two adjacent upper supporting posts 212 of the top plate 21 and abuts against the top end of the guiding rod 27.

The driving unit 30 has two torsion spring wheels 31 and a torsion spring 35. Each of the torsion spring wheels 31 has a first upper toothed disc 32, a first lower toothed disc 33 and a first axle 34. The first axle 34 is rotatably sleeved onto one pair of the upper axles 214 and the lower axles 223 of the base 20. The top and bottom ends of the first axle 34 are integrally connected with the first upper and lower toothed discs 32 and 33 respectively. The torsion spring 35 connects the first axles 34 of the two torsion spring wheels 31 for providing resilient force to drive the two torsion spring wheels 31 to rotate synchronously.

The cord rolling unit 40 has a cord rolling wheel 41, a first lift transmission cord 48, and a second lift transmission cord 49. The cord rolling wheel 41 has a second upper toothed disc 42, a second lower toothed disc 43, and a second axle 44. The second upper and lower toothed discs 42 and 43 are engaged with the first upper and lower toothed discs 32 and 33 of one of the torsion spring wheels 31 of the driving unit 30 respectively. The second axle 44 is rotatably sleeved onto another pair of the upper axles 214 and one of the lower axles 223 of the base 20. The top and bottom ends of the second axle 44 are integrally connected with the second upper and lower toothed discs 42 and 43 respectively; so that the cord rolling wheel 41 can be driven by the two torsion spring wheels 31 through the engagement and transmission therebetween to rotate synchronously. Besides, as shown in FIGS. 2-3, the second axle 44 has an upper axial portion 45, a lower axial portion 46, and a separating portion 47. An end of the upper axial portion 45 and an end of the lower axial portion 46 are integrally connected with the second upper toothed disc 42 and the second lower toothed disc 43 respectively. The separating portion 47 is integrally connected between the upper and lower axial portions 45 and 46. The limiting ring 28 of the base 20 is located correspondingly to the upper axial portion 45. Besides, the external radius of the upper axial portion 45 gradually decreases from the second upper toothed disc 42 to the separating portion 47. The external radius of the lower axial portion 46 gradually decreases from the second lower toothed disc 43 to the separating portion 47. An end of the first lift transmission cord 48 is connected with the upper axial portion 45 of the second axle 44. An end of the second lift transmission cord 49 is connected with the lower axial portion 46 of the second axle 44. Therefore, the first and second lift transmission cords 48 and 49 are separated from each other by the separating portion 47 of the second axle 44, thereby prevented from entwining and knotting. An opposing end of the first lift transmission cord 48 is inserted through the limiting ring 28 and abutted against the guiding rod 27 as shown in FIGS. 3 and 4, and then extends out of the base 20 through the first opening 23, for being connected with an end of a bottom beam which belongs to the prior art and is not shown in the figures. Further, an opposing end of the second lift transmission cord 49 extend out of the base 20 through the second opening 24 as shown in FIGS. 3 and 4, for being connected with an opposing end of the bottom beam. As a result, the bottom beam will not incline to one side when being pulled by the first and second lift transmission cords 48 and 49, so that the force applied to the bottom beam is balanced.

It can be understood from the above illustration that when the first and second lift transmission cords 48 and 49 are pulled out at the same time to gradually released from the upper and lower axial portions 45 and 46 of the second axle 44 of the cord rolling wheel 41, the cord rolling wheel 41 drives the torsion spring wheel 31 engaged with the cord rolling wheel 41 through the engagement therebetween, and then the torsion spring wheel 31 driven by the cord rolling wheel 41 further drives the other torsion spring wheel 31 through the engagement therebetween. At this time, the torsion spring 35 is stretched by the two torsion spring wheels 31 so as to accumulate resilient force. When the pulling force applied on the first and second lift transmission cords 48 and 49 is relieved, the resilient force of the torsion spring 35 is applied on the two torsion spring wheels 31, causing the two torsion spring wheels 31 to rotate synchronously in opposite directions. The torsion spring wheel 31 engaged with the cord rolling wheel 41 drives the cord rolling wheel 41 by the engagement therebetween, causing the cord rolling wheel 41 to roll up the first and second lift transmission cords 48 and 49 around the upper and lower axial portions 45 and 46 of the second axle 44 at the same time.

Besides, in order that the first and second lift transmission cords 48 and 49 are provided with appropriate resistance when operating, the first and second lift transmission cords 48 and. 49 are respectively wound around at least one first vertical rod 25 and at least one second vertical rod 26. In this embodiment, as shown in FIG. 4, the first lift transmission cord 48 is wound around two of the first vertical rods 25 and then extends out of the base 20 through the first opening 23, and the second lift transmission cord 49 is wound around two second vertical rods 26 and then extends out of the base 20 through the second opening 24. In practice, however, the arrangement of the first and second vertical rods 25 and 26 and the way that the first and second lift transmission cords 48 and 49 are wound are both adjustable according to the practical demands For example, the amounts of the first and second vertical rods 25 and 26 that are employed may be one or more, and the first and second lift transmission cords 48 and 49 may be wound around one or a plurality of first and second vertical rods 25 and 26 respectively, or even wound around every first and second vertical rods 25 and 26 respectively. In other words, through the variation of the amounts and the positions of the first and second vertical rods 25 and 26 and the timely adjustment of the cord arrangement of the first and second lift transmission cords 48 and 49, the resistance provided on the first and second lift transmission cords 48 and 49 can be adjusted.

In conclusion, in the three-wheeled cord rolling device 10 of the present invention, the first and second lift transmission cords 48 and 49 are disposed on the same cord rolling wheel 41 in a vertically separated manner, and the cord rolling wheel 41 can rotate with the two torsion spring wheels 31 synchronously by the engagement and transmission therebetween. As a result, the three-wheeled cord rolling device is shortened in length of the whole without being affected in transmission effect, thereby attaining the effect of structural simplification.

What is claimed is:

1. A three-wheeled cord rolling device for a non-pull cord window blind, the three-wheeled cord rolling device comprising:
a base;
a driving unit having two torsion spring wheels and a torsion spring, each of the torsion spring wheels being rotatably disposed on the base and having a first upper toothed disc, a first lower toothed disc and a first axle connecting the first upper toothed disc and the first lower toothed disc, the torsion spring connecting the first axles of the two torsion spring wheels; and
a cord rolling unit having a cord rolling, a first lift transmission cord and a second lift transmission cord, the cord rolling wheel being rotatably disposed on the base and having a second upper toothed disc, a second lower toothed disc and a second axle, the second upper toothed disc and the second lower toothed disc being engaged with the first upper toothed disc and the first lower toothed disc of one of the torsion spring wheels of the driving unit respectively, the second axle having an upper axial portion, a lower axial portion and a separating portion, an end of the upper axial portion and an end of the lower axial portion being connected with the second upper toothed disc and the second lower toothed disc respectively, the separating portion being connected between the upper axial portion and the lower axial portion, the first lift transmission cord and the second lift transmission cord being disposed on the upper axial portion and the lower axial portion of the second axle respectively and separated from each other by the separating portion of the second axle.

2. The three-wheeled cord rolling device as claimed in claim 1, wherein the base is provided at two opposite ends thereof with a first opening and a second opening respectively, and the base is further provided on one side thereof with a guiding rod and a limiting ring; and located correspondingly to the upper axial portion of the cord rolling wheel; the first lift transmission cord is inserted through the limiting ring and abutted against the guiding rod; an end of the first lift transmission cord is connected with the upper axial portion of the second axle; an opposing end of the first lift transmission cord extends out of the base through the first opening of the base; an end of the second lift transmission cord is connected with the lower axial portion of the second axle; an opposing end of the second lift transmission cord extends out of the base through the second opening of the base.

3. The three-wheeled cord rolling device as claimed in claim 2, wherein the base further has a first vertical rod disposed adjacent to the first opening, and a second vertical rod disposed adjacent to the second opening; the first lift transmission cord is abutted against the first vertical rod; the second lift transmission cord is abutted against the second vertical rod.

4. The three-wheeled cord rolling device as claimed in claim 2, wherein the base further has a plurality of first vertical rods disposed adjacent to the first opening, and a plurality of second vertical rods disposed adjacent to the second opening; the first lift transmission cord is abutted against at least one of the first vertical rods; the second lift transmission cord is abutted against at least one of the second vertical rods.

5. The three-wheeled cord rolling device as claimed in claim 1, wherein an external radius of the upper axial portion of the second axle gradually decreases from the second upper toothed disc to the separating portion of the second axle; an external radius of the lower axial portion of the second axle gradually decreases from the second lower toothed disc to the separating portion of the second axle.
